(19) United States
(12) Patent Application Publication
(10) Pub. No.: US 2020/0001595 A1
(43) Pub. Date: Jan. 2, 2020

(54) METHOD OF DEPOSITING WET PRINTED SHEETS AND FORMING A SHEET STACK

(71) Applicant: HEIDELBERGER DRUCKMASCHINEN AG, Heidelberg (DE)

(72) Inventors: SEBASTIAN WILHELM, SCHWETZINGEN (DE); RAINER HOFMANN, HIRSCHHORN (DE); SABINE ROEHL, HEIDELBERG (DE); JAN GASSENSCHMIDT, BAD KROZINGEN (DE); ROLF MUELLER, NUSSLOCH (DE)

(21) Appl. No.: 16/418,230

(22) Filed: May 21, 2019

(30) Foreign Application Priority Data
Jun. 27, 2018 (DE) 102018210485.9

(51) Int. Cl. B41F 23/04; B41J 11/00

(52) U.S. Cl. CPC B41F 23/0443; B41J 13/076; B41J 11/007; B41J 11/0015

(57) ABSTRACT

A method for depositing wet printed sheets and forming a sheet stack in a delivery of a printing machine. An auxiliary stack which is separate from the sheet stack has sheet-shaped intermediate layers that are usable as moisture barriers in the sheet stack. A plurality of sheets are stacked on top of one another to form a first section of the sheet stack. Then an intermediate layer is moved from the auxiliary stack onto the section of the sheet stack. A plurality of sheets are stacked on top of one another and on the intermediate layer to form a further section. The intermediate layer is thus arranged in the sheet stack between the first section and the further section. The placement of the intermediate layers provides a way of reducing or even eliminating quality losses in sheets and/or sheet stacks caused by moisture and moisture exchange.

### CROSS-REFERENCE TO RELATED APPLICATION

This application claims the priority, under 35 U.S.C. § 119, of German patent application DE 10 2018 210 485,9, filed Jun. 27, 2018; the prior application is herewith incorporated by reference in its entirety.

### BACKGROUND OF THE INVENTION

### Field of the Invention

The invention relates o a method for depositing wet printed sheets and forming a sheet stack.

The invention lies in the technical field of the graphic industry and in particular the field of printing on sheets, for instance made of paper, and depositing them on a sheet stack.

During the printing operation, moisture may be introduced into the sheets. The moisture may, for instance, be introduced into the sheets via the applied printing ink, dampening solution, or varnish. The moisture that is introduced may cause the sheets to expand and then to shrink again in the drier. In addition, the moisture that is introduced may cause waves to be created, a phenomenon also known as curling. In addition, a stack that is formed of sheets may exhibit moisture-related irregularities.

German published patent application G 14257 discloses a printing process wherein the print sheets and intermediate sheets are jointly moved and deposited in pairs. In the stack of sheets that is formed, print sheets and intermediate sheets alternate. The intermediate sheets are intended to prevent printing ink from smearing off on the rear side of the following sheet.

U.S. Pat. No. 6,610,388 B2 and its counterpart European Patent EP 1 401 664 B1 disclose a method for producing ink jet recording media wherein a coating that is cured by radiation is applied to a surface of a substrate material. In this way, a barrier layer against moisture is created on the substrate.

### BRIEF SUMMARY OF THE INVENTION

It is accordingly an object of the invention to provide a method of depositing fresh printed sheets and forming a sheet stack which overcomes the above-mentioned and other disadvantages of the heretofore-known devices and methods of this general type and which, in particular, allows quality losses caused by moisture and moisture exchange in sheets and/or sheet stacks to be reduced or even avoided.

With the foregoing and other objects in view there is provided, in accordance with the invention, a method of depositing wet printed sheets and forming a sheet stack in a delivery of a printing machine, the method comprising:

a) providing sheet-shaped intermediate layers on an auxiliary stack that is different from the sheet stack, the intermediate layers being configured to be used as moisture barriers in a sheet stack;

b) depositing a plurality of sheets on top of one another and forming a first section of the sheet stack;

c) moving an intermediate layer from the auxiliary stack onto the first section of the sheet stack; and

d) depositing a plurality of sheets on the intermediate layer and on top of one another to form a further section of the sheet stack, with the intermediate layer arranged between the first section and the further section of the sheet stack.

In other words, the objects of the invention are achieved by a method which provides for sheet-shaped intermediate layers that usable as moisture barriers in the sheet stack. The intermediate layers are stacked on an auxiliary stack that is separate from the sheet stack. A partial sheet stack, or section, is formed by depositing a plurality of sheets on top of one another. Next, an intermediate layer is moved from the auxiliary stack to the partial sheet stack. Next, a further partial sheet stack, or further section, is formed by depositing a plurality of sheets on top of one another and on the intermediate layer. The intermediate layer is thus arranged between the two (or more) partial sheet stack, or sections.

The sheets may have been printed in an inkjet printing process or in a lithographic offset printing process. The ink may preferably be water-based ink. The sheets may be made of paper, cardboard, or paperboard.

The invention advantageously provides a way of reducing or even eliminating quality losses in sheets and/or sheet stacks caused by humidity and humidity exchange. In particular, undesired diffusion processes between sheets or sheet stack sections of different moisture contents (and potentially of different temperatures) or between sheets or sheet stack sections and the environment may be reduced or avoided.

It is an advantage of the invention that the partial sheet stacks, that is, the first section of the sheet stack and the further section of the sheet stack, consist of a plurality of sheets. This means that in contrast to the prior art, the intermediate layers do not constitute one half of the sheet stack. In particular when the stack is further processed, this is advantageous because the (few) intermediate layers may easily be removed.

An intermediate layer may advantageously be moved onto the sheet stack when the print image changes. A change in the print image may result in changed amounts of moisture in the sheets and in the corresponding section of the sheet stack. Therefore a moisture barrier between such sections of the sheet stack may be advantageous.

Once the process has been completed, there is at least one intermediate layer present in the sheet stack. The intermediate layer thus separates a lower section of the sheet stack from an upper section of the sheet stack.

The movement of the intermediate layer from the auxiliary stack to the section of the sheet stack and/or the introduction of the sheets into the sheet stack are done in an automated way (i.e. not by hand) and preferably separately, i.e. an individual intermediate layer is separately moved from the auxiliary stack to the sheet stack. In contrast with the prior art, intermediate layers are not moved together with sheets, thus avoiding the problems inherent in a joint transportation such as undesired relative movements. The intermediate layers may be lifted off the auxiliary stack by means of a suction head to be transported to the sheet stack by means of rollers and/or belts. Blown air may be provided to assist in the movement. The movement may be substantially parallel to the direction of sheet travel or transverse thereto.

The auxiliary stack may be disposed in the vicinity of the sheet stack. Like the sheet stack, the auxiliary stack may be disposed in the delivery of a printing machine. Alternatively, the sheet stack may be disposed in a different location in the printing machine and the intermediate layers may be conveyed from the auxiliary stack to the sheet stack via a conveying section. The auxiliary stack may be disposed upstream or downstream of the sheet stack in the direction of sheet transport. Alternatively, the sheet stack may be disposed on a side of the sheet stack—either on the so-called drive side or on the so-called operator side of the printing machine. Like the sheet stack, the auxiliary stack may be vertically adjustable.

The intermediate layer preferably has a continuous surface. The continuous surface preferably forms an a real contact with both the sheet disposed below the intermediate layer and the sheet above the intermediate layer in the sheet stack. The intermediate layer preferably does not have any holes, i.e. it is hole-free or non-perforated.

In a preferred embodiment, the intermediate layer is a substantially two-dimensional object and not a three-dimensional one, in particular not an auxiliary stack carrier that is made of wood, for instance. The intermediate layer only has a negligible influence on the height of the sheet stack.

The intermediate layer is preferably supported on a sheet in the sheet stack, in particular on the entire surface of the sheet.

The intermediate layer may have a format that corresponds to the format of the sheets in the sheet stack. Alternatively, the intermediate layer may have a larger format and may laterally protrude from the sheet stack. The respective lateral protrusion of the intermediate layer may hang down, laterally protecting the sheet stack from a moisture exchange with the environment.

In accordance with an added feature of the invention, the movement of the intermediate layer from the auxiliary stack onto the sheet stack occurs at a predefined point in time. The point in time may be saved on a computer and the computer may control the movement of the intermediate layer from the auxiliary stack onto the sheet stack. If multiple intermediate layers are introduced into the sheet stack, multiple points in time may be specified. The points in time may define periods of time of a predefined length. For instance, an intermediate layer may be inserted into the sheet stack every 10 seconds, or every 30 seconds, or every 60 seconds. Various time periods may be set.

In accordance with an additional feature of the invention, the movement of the intermediate layer from the auxiliary stack onto the sheet stack may take place once a predefined plurality of sheets have been deposited on top of one another. The predefined plurality of sheets may be saved as a numerical value on a computer and the computer may control the movement of the intermediate layer from the auxiliary stack onto the sheet stack. If multiple intermediate layers are introduced into the sheet stack, multiple such values may be specified. The sheet stack sections that are formed in this way may have the same height. Alternatively, the height of the sheet stack sections may vary. For instance, an intermediate layer may be inserted into the sheet stack after every 10 sheets, or every 50 sheets, or every 100 sheets.

In accordance with an preferred embodiment of the invention, step c) (i.e., insert intermediate layer) and step d) (i.e., form further partial stack) are carried out multiple times to introduce multiple intermediate layers into the sheet stack. In this way, for instance two, three, four, or more intermediate layers may be introduced.

A preferred further development of the invention may be characterized in that in addition, a first intermediate layer is arranged at the lower side of the sheet stack. In addition or as an alternative, a last intermediate layer may additionally be arranged on the upper side of the sheet stack. In this way, the sheet stack may be protected from a moisture exchange with the environment or with a stack pallet from below or from above.

In accordance with a further feature of the invention, the movement of he intermediate layer from the auxiliary stack onto the sheet stack occurs during a flying phase of a sheet to be deposited. The flying phase is preferably a phase between the point when the sheet is released from a gripper engagement of a sheet-conveying gripper and the point when the sheet meets the upper side of the sheet stack. In this way, damage to the sheets and in particular to a printed image may be avoided. The intermediate layer may advantageously be fed to the sheet stack in such a way that any sliding on the upper sheet may be prevented. For this purpose, the space between the uppermost sheet and a sheet to be deposited (and in the flying phase) may be used. The intermediate layer may itself have a flying phase during the movement.

A preferred further development of the invention is that the intermediate layer is a plastic film having a thickness of less than 0.5 mm, for instance, or a plastic sheet, preferably a flexible plastic sheet, having a thickness of less than 1 mm, for instance. Alternatively, a metalized foil or a metal film may be used.

In accordance with again an added feature of the invention, the intermediate layer or all intermediate layers is/are removed when the sheet stack is further processed. The removal may take place, for instance, in a feeder of a folding machine.

In accordance with a concomitant feature of the invention, both the upper side and the lower side of the intermediate layer contact a respective sheet. In this way, space may be prevented from forming between the sheets and the intermediate layer, in particular air-filled space.

Alternatively, instead of providing the intermediate layer into the delivery sheet stack, the intermediate layer may be introduced into the sheet stream in the feeder and transported to the delivery sheet stack through the printing machine. In this case, the auxiliary stack would preferably be disposed in the vicinity of the feeder. A further alternative is to supply a sheet stack that has already been provided with at least one intermediate layer at a defined location.

Other features which are considered as characteristic for the invention are set forth in the appended claims.

Although the invention is illustrated and described herein as embodied in a method for depositing wet printed sheets on a sheet stack, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 illustrates a side view of a printing machine carrying out a preferred embodiment of the method of the invention; and

FIG. 2 is a flow chart of a preferred embodiment of the method of the invention.

### DETAILED DESCRIPTION OF THE INVENTION

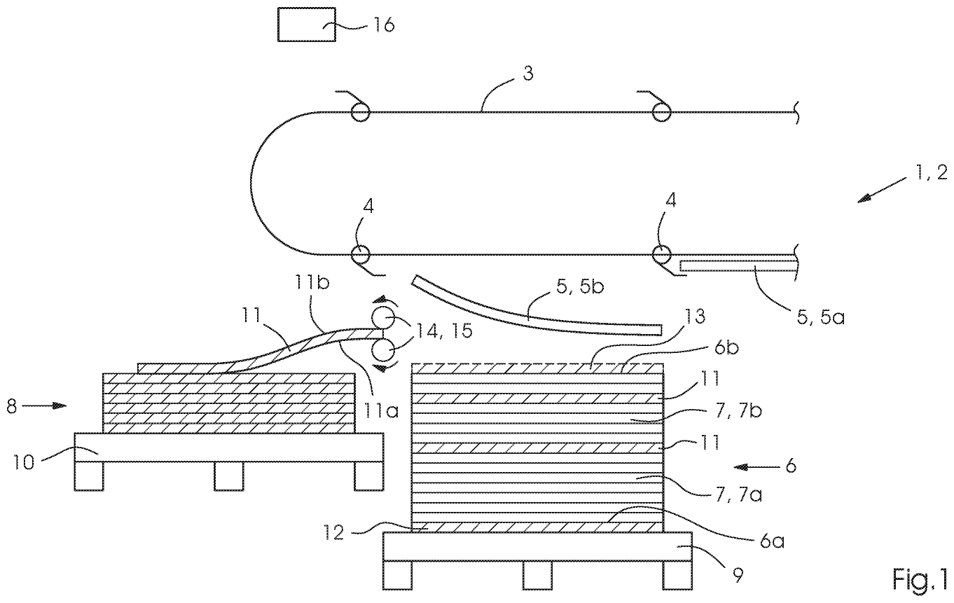

Referring now to the figures of the drawing in detail and first, particularly, to FIG. 1 thereof, there is shown a printing machine 1 such as an inkjet printing machine or a lithographic offset printing machine. The printing machine comprises a delivery 2 including a chain conveyor 3 with grippers 4 for holding the printed sheets 5. Reference symbol 5a indicates a sheet that is being transported (and held in gripper engagement); reference symbol 5b illustrates a falling sheet (in its flying phase) that is being deposited on a sheet stack 6. The sheet stack has a lower side 6a and an upper side 6b. The sheet stack is located on a stack pallet 9 and is preferably vertically adjustable. In the vicinity of the stack pallet, there is an auxiliary stack pallet 10 supporting an auxiliary stack 8 of intermediate layers 11. The auxiliary stack pallet is preferably likewise vertically adjustable.

In accordance with the method of the invention, intermediate layers 11 (at least one, preferably multiple intermediate layers) are introduced into the sheet stack 6. In this way, sections 7 (here, 7a and 7b) of the sheet stack 6 are created. As shown, the intermediate layers 11 are located inside the sheet stack 6 and both the lower sides 11a and the upper sides 11b contact adjacent sheets 5. It is further shown that a first intermediate layer 12 may be disposed on the lower side 6a of the sheet stack 6 and a last intermediate layer 13 may be disposed on the upper side 6b of the sheet stack. In a case in which a last intermediate layer 13 is provided, no further sheet 5 is deposited on the sheet stack.

The intermediate layers 11 are fed/moved by means of a feed device 14, which may, for instance, comprise at least two rollers 15. The feed device 14 may be controlled by a computer 16 of the printing machine 1.

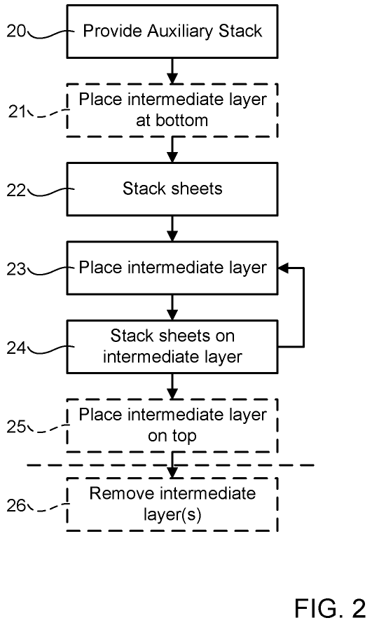

FIG. 2 is a flow chart of a preferred embodiment of the method of the invention. Optional and preferred steps of the method are illustrated within dashed-line boxes. Step 20 comprises providing the intermediate layers 11 on the auxiliary stack 8. In an optional step 21, a first intermediate layer 12 is arranged on the lower side 6a of the sheet stack 6. In a step 22, a plurality of sheets 5 is disposed on top of one another and a section 7/7a of the sheet stack is formed. In a step 23, an intermediate layer 11 is moved from the auxiliary stack 8 onto the section of the sheet stack 6. In a step 24, a plurality of sheets 5 is deposited on top of one another and on the intermediate layer 11 and a further section 7/7b of the sheet stack 6 is formed with the intermediate layer 11 arranged between the section and the further section of sheet stack. Steps 23 and 24 may be carried out multiple times to allow multiple intermediate layers to be introduced into the sheet stack. In an optional step 25, a last intermediate layer 13 is arranged on the upper side 6b of the sheet stack 6. In an optional step 26, the intermediate layer that has been introduced or the multiple intermediate layers may be removed from the sheet stack 6.

While the layers 11 are described as “intermediate layers,” it will be understood that they are also used as a stack base layer, or a lowermost layer under a sheet stack, and as a top layer, i.e., the uppermost layer on a sheet stack.

The following is a summary list of reference numerals and the corresponding structure used in the above description of the invention:
1 printing machine
2 delivery
3 chain conveyor
4 gripper
5 sheet
5a transported sheet
5b falling sheet (flying phase)
6 sheet stack
6a lower side of the sheet stack
6b upper side of the sheet stack
7 section/sections of the sheet stack
7a section/sections of the sheet stack
7b section/sections of the sheet stack
8 auxiliary stack
9 stack pallet
10 auxiliary stack pallet
11 intermediate layer
11a lower side of the intermediate layer
11b upper side of the intermediate layer
12 first intermediate layer
13 last intermediate layer
14 feed device
15 rollers
16 computer, controller
20 step of providing
21 optional step of providing a first intermediate layer
22 step of depositing a plurality of sheets
23 step of moving an intermediate layer
24 step of depositing a plurality of sheets
25 optional step of providing a last intermediate layer
26 optional step of removing the intermediate layer

1. A method of depositing wet printed sheets and forming a sheet stack in a delivery of a printing machine, the method comprising:
a) providing sheet-shaped intermediate layers on an auxiliary stack that is different from the sheet stack, the intermediate layers being configured to be used as moisture barriers in a sheet stack;
b) depositing a plurality of sheets on top of one another and forming a first section of the sheet stack;
c) moving an intermediate layer from the auxiliary stack onto the first section of the sheet stack; and
d) depositing a plurality of sheets on the intermediate layer and on top of one another to form a further section of the sheet stack, with the intermediate layer arranged between the first section and the further section of the sheet stack.

2. The method according to claim 1, wherein the moving step comprises moving the intermediate layer from the auxiliary stack to the sheet stack at a specified point in time.

3. The method according to claim 1, wherein the moving step comprises moving the intermediate layer from the auxiliary stack to the sheet stack after a predefined number of sheets has been deposited on top of one another.

4. The method according to claim 1, which comprises repeating steps c) and d) multiple times to arrange multiple intermediate layers in the sheet stack.

5. The method according to claim 1, which comprises placing a first intermediate layer on a lower side below the sheet stack.

6. The method according to claim 1, which comprises placing a last intermediate layer on a top of the sheet stack.

7. The method according to claim 1, wherein the moving step comprises moving the intermediate layer from the auxiliary stack to the sheet stack during a flying phase of a sheet being deposited.

8. The method according to claim 1, wherein the intermediate layer is a plastic film or a plastic sheet having a thickness of less than 1 mm.

9. The method according to claim 1, which comprises removing the intermediate layer from the sheet stack during further processing of the sheet stack.

10. The method according to claim 4, which comprises removing the intermediate layers from the sheet stack during further processing of the sheet stack.

11. The method according to claim 1, wherein the intermediate layer has a lower side and an upper side each in contact with a respective sheet of the sheet stack.
